(19) United States
(12) Patent Application Publication
(10) Pub. No.: US 2005/0213687 A1
(43) Pub. Date: Sep. 29, 2005

(54) Receiving apparatus

(75) Inventors: Seiji Matsui, Anpachi-gun (JP); Yoshiharu Doi, Mizuho-shi (JP)

Correspondence Address: MCDERMOTT WILL & EMERY LLP, 600 13TH STREET, N.W., WASHINGTON, DC, 20005-3096, US

(73) Assignee: Sanyo Electric Co., Ltd.

(21) Appl. No.: 11/087,702

(22) Filed: Mar. 24, 2005

(30) Foreign Application Priority Data
Mar. 24, 2004 (JP) 2004-087784

(51) Int. Cl. H04L 27/06

(52) U.S. Cl. 375/316; 375/347

(57) ABSTRACT

Radio units perform frequency-conversion from radio-frequency analog signals received by antennas to baseband analog signals. The radio units detect the strength of the baseband analog signals and output it as RSSIs. A generating unit generates a single pseudo RSSI from a plurality of RSSIs. A-D units perform analog-to-digital conversion on analog received signals and then outputs digital received signals. A plurality of multipliers weight the digital received signals with receiving weight vector signals, and an adder adds up outputs of the multipliers so as to output a digital composite signal. Another multiplier carries out an automatic gain control (AGC) of the digital composite signal. In a demodulation unit, an analog composite signal is subjected to analog-to-digital conversion, the thus converted signal is subjected to an de-spread processing and the thus de-spread signal is then demodulated.

### BACKGROUND OF INVENTION

1. Field of the Invention

The present invention relates to the receiving technology, and it particularly relates to receiving apparatus utilizing the adaptive array antenna technique.

2. Description of the Related Art

In wireless communication, it is generally desired that the limited frequency resources be used effectively. Adaptive array antenna technology is one of the technologies that can realize effective utilization of frequency resources. In the adaptive array antenna technology, the amplitude and phase of signals transmitted and received by a plurality of antennas, respectively, are so controlled as to form a directional pattern of the antenna for transmission and receiving. In other words, the apparatuses provided with adaptive array antennas change the amplitude and phase of signals received by their respective antennas, add up the thus changed received signals, and receive the signals equivalent to the signals received by the antenna having the directional pattern corresponding to the variation in the said amplitude and phase (hereinafter referred to as “weight”). In addition, signals are transmitted in a directional, pattern of the antenna corresponding to the weight.

One example of weight computation in the adaptive array antenna technology is a processing based on the MMSE (Minimum Mean Square Error) method. In the MMSE method, the Wiener solution is known to be the condition for an optimum weight value. Also known is a recurrence formula whose amount of calculation is smaller than directly solving the above-mentioned condition. For such recurrence formula, adaptive algorithms, such as RLS (Recursive Least Squares) algorithm and LMS (Least Mean Squares) algorithm, are used (See reference (1) in the following Related Art List, for instance).

Related Art List

(1) Japanese Patent Application Laid-Open No. 2000-286777.

There is a case where a communication apparatus compatible with wireless LAN (Local Area Network) and the like is comprised of at least two or more chips. For instance, there is a communication apparatus comprised of, as the receiving functions, an RF chip which receives the input of received RF analog signals, performs frequency conversion on the inputted RF analog signals and then outputs baseband analog signals, and a baseband chip which receives the input of the baseband analog signals, performs analog-to-digital conversion on the analog signals and demodulates digital signals. The communication apparatus thus configured as above does not comply with the adaptive array antenna technology. The baseband chip generally uses the magnitude of RSSI (Recevied Signal Strength Indicator) as a start trigger of a processing. And the RSSI of a single system can be inputted from an external source. Thus, a plurality of RSSIs corresponding to a plurality of signals received respectively by a plurality of antennas cannot all be inputted in the same way as in the adaptive array antenna technique. Since the baseband chip carries out the analog-to-digital conversion, an AGC (Automatic Gain Control) needs to be operated in the front-end in order to improve the degree of accuracy thereof.

### SUMMARY OF THE INVENTION

The present invention has been made in view of the foregoing circumstances and an object thereof is to provide a receiving apparatus that processes a plurality of RSSIs and outputs one RSSI.

A preferred embodiment according to the present invention relates to a receiving apparatus. This apparatus comprises: a frequency conversion unit which frequency-converts a plurality of received analog signals to a plurality of baseband analog signals, respectively; a synthesis unit which synthesizes the plurality of baseband analog signals that have been frequency-converted by the frequency conversion unit; and a demodulation unit which converts the synthesized analog signal to a digital signal and then demodulates the digital signal. In this apparatus, the frequency conversion unit may derive respectively a plurality of signals indicative of reception strength relative to the plurality of received analog signals; the synthesis unit may process the plurality of signals indicative of the reception strength and then derive a single signal indicative of the reception strength; and the synthesized analog signal inputted to the demodulation unit may have a band which is approximately equal respectively to bands of the plurality of frequency-converted baseband analog signals outputted from the frequency conversion unit, and the demodulation unit may convert the synthesized analog signal to a digital signal and demodulate the digital signal in a manner of reflecting the single signal indicative of the reception strength thereon.

The “synthesis” includes not only a case when a plurality of signals are merely synthesized but also a case when a plurality of signals are synthesized while the signals are being weighted. It further includes a case where weighting factors vary adaptively in doing the weighting, and it is called, as such, as long as a plurality of signals are finally synthesized.

“In a manner of reflecting the single signal indicative of the reception strength thereon” includes also a case when the single signal indicative of the reception strength is used not only directly but also indirectly. For instance, even if the single signal indicative of the reception strength is used only as an initial value in a feedback loop and thereafter it will not be used at all, an influence of the single signal indicative of the reception strength still remains in the feedback loop. And this example falls into the phraseology of “in a manner of reflecting the single signal indicative of the reception strength thereon”.

By employing the above-structured apparatus, the synthesis unit derives a single signal indicative of reception strength, based on a plurality of signals indicative of reception strength, and the demodulation unit operates based on a single signal indicative of reception strength. Hence, for example, even when the reception strengths of a plurality of signals indicative of reception strength are small, a single signal indicating the reception strength in which a correction has been effected can raise the reliability of operations of the receiving apparatus.

The synthesis unit may average the plurality of signals indicative of the reception strength and then derive the single signal indicative of the reception strength. The synthesis unit may output a signal stored beforehand based on timing at which the plurality of signals indicative of the reception strength were inputted, synthesize the thus outputted signal with the plurality of averaged signals, and then derive the single signal indicative of the reception strength. The synthesis unit may carry out synthesis according to values of reception strength corresponding respectively to the plurality of frequency-converted baseband analog signals while the plurality of signals indicative of the reception strength are being weighted, and then derive the single signal indicative of the reception strength. The synthesis unit may select one signal from the plurality of signals indicative of the reception strength, and then derive the single signal indicative of the reception strength. The synthesis unit may output the signal stored beforehand as a signal indicative of the reception strength, based on the timing at which the plurality of signals indicative of the reception strength were inputted.

The synthesis unit may convert respectively the plurality of frequency-converted baseband analog signals into a plurality of digital signals, convert the plurality of digital signals into analog signals after synthesis, and derive respectively amplification factors for the plurality of frequency-converted baseband analog signals to be outputted from the frequency conversion unit, based on the plurality of frequency-converted baseband analog signals, with an initial value as a signal indicative of the reception strength; and the frequency conversion unit may amplify respectively the plurality of frequency-converted baseband analog signals, based on the thus derived amplification factors, and output the amplified signals.

With one signal indicative of the reception strength as an initial value, the demodulation unit may derive an amplification factor for the synthesized analog signals to be outputted from the synthesis unit, based on the synthesized analog signals; and the synthesis unit may amplify the synthesized analog signal, based on the thus derived amplification factor, and output the amplified signal. With one signal indicative of the reception strength as an initial value, the demodulation unit may derive an amplification factor for the synthesized analog signals, based on the synthesized analog signals, and the apparatus may further comprise an amplifying unit which amplifies the synthesized signals based on the amplification factor and outputs the amplified signals to the demodulation unit.

Another preferred embodiment according to the present invention relates also to a receiving apparatus. This apparatus comprises: a synthesis unit which synthesizes a plurality of inputted analog signals; and a demodulation unit which converts the synthesized analog signals into digital signals and demodulates the digital signals. In this apparatus, the demodulation unit may derive an amplification factor for the synthesized analog signals to be outputted form the synthesis unit, based on the synthesized analog signals; and the synthesis unit may amplify the plurality of synthesized analog signals based on the derived amplification factor and then output the amplified signals to the demodulation unit.

By employing the above-structured apparatus, the operation for setting amplification factors and the operation for amplifying signals can be carried out in a clearly separated manner between the amplifying unit and the demodulation unit, so that a stable operation can be realized.

Still another preferred embodiment according to the present invention relates also to a receiving apparatus. This apparatus comprises: a synthesis unit which synthesizes a plurality of inputted analog signals; an amplifying unit which amplifies the synthesized signals; and a demodulation unit which converts the amplified analog signals into digital signals and demodulates the digital signals. In this apparatus, the demodulation unit may derive an amplification factor for the amplified analog signals to be outputted form the amplifying unit, based on the amplified analog signals; and the amplifying unit may amplify the plurality of synthesized analog signals based on the derived amplification factor.

Still another preferred embodiment according to the present invention relates also to a receiving apparatus. This apparatus comprises: a first chip which frequency-converts a plurality of received analog signals to a plurality of baseband analog signals, respectively and outputs the plurality of converted baseband analog signals as a plurality of first signals; a second chip which inputs the plurality of first signals, synthesizes the plurality of frequency-converted baseband analog signals and outputs the synthesized signal as a second signal; and a third chip which inputs the second signal, converts the synthesized analog signal to a digital signal and then demodulates the digital signal. In this apparatus, the first chip may derive respectively a plurality of signals indicative of reception strength relative to the plurality of received analog signals; the second chip may process the plurality of signals indicative of the reception strength and then derive a single signal indicative of the reception strength; and the second signal inputted to the third chip may have a band which is approximately equal respectively to bands of the plurality of first signals outputted from the first chip, and the third chip may convert the synthesized analog signal to a digital signal in a manner of reflecting the single signal indicative of the reception strength.

It is to be noted that any arbitrary combination of the above-described structural components and expressions changed among a method, an apparatus, a system, a recording medium, a computer program and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a structure of a receiving apparatus according to a first embodiment of the present invention.

FIG. 2 shows a structure of a burst format according to the first embodiment of the present invention.

FIG. 3 shows a structure of a first radio unit shown in FIG. 1.

FIG. 4 shows a structure of a generating unit shown in FIG. 1.

FIG. 5 shows a structure of a receiving weight vector computing unit shown in FIG. 1.

FIG. 6 shows a structure of a demodulation unit shown in FIG. 1.

FIG. 7 shows a structure of a generating unit according to a second embodiment of the present invention.

FIG. 8 shows a structure of a receiving apparatus according to a third embodiment of the present invention.

FIG. 9 shows a structure of a generating unit shown in FIG. 8.

FIG. 10 shows a structure of a receiving apparatus according to a fourth embodiment of the present invention.

FIG. 11 shows a structure of a generating unit shown in FIG. 10.

FIG. 12 shows a structure of a receiving apparatus according to a fifth embodiment of the present invention.

FIG. 13 shows a structure of a generating unit shown in FIG. 12.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

Before describing the present invention in detail through specific embodiments, the problems to be solved by the present invention will first be described in further detail. In order to functionally and structurally expand a communication apparatus constituted by the above-described RF chip and baseband chip and make this apparatus compatible with the adaptive array technology, it is preferable that a processing chip for executing adaptive array signal processings be placed between a plurality of RF chips corresponding to a plurality of antennas and a baseband chip. This processing chip is equivalent to an interface between the RF chips and the baseband chip. Thus, after baseband analog signals are inputted and are then subjected to analog-to-digital conversion, an adaptive array processing is carried out. Then, after subjecting the thus A-D converted signals to digital-to-analog conversion, baseband analog signals are outputted. By employing this structure, even if the RF chips as well as the baseband chip are changed, the interface between the RF chips and the baseband chip is maintained, thus making the development of communication apparatus easier.

As described before, the baseband chip can only receive the input of single RSSI. Hence, if a structure is provided for the adaptive array antenna, the RSSI outputted from one of a plurality of RF chips is inputted to the baseband chip. As a result, the receiving characteristics of signals might improve due to the adaptive array technology. If, however, the RSSI outputted from the RF chips is small, the baseband chip will not start a processing and thus fail to receive signals. Moreover, in a communication apparatus compatible with the adaptive array antenna, the analog-to-digital conversion is done in a processing chip and a baseband chip. Hence, it is preferable that, in order to improve the degree of accuracy of these chips the respective, AGCs respectively adjust the reception strength of the analog signals in the front-end. In particular, no AGC was ever provided between the processing chip and the baseband chip under the conventional practice. Thus, the signal strength (amplitude) needs to be adjusted between a chip for carrying out an adaptive array processing and a chip for carrying out demodulation.

First embodiment

Before describing the present invention in a specific manner, an outline of the present invention will be described herein. A first embodiment according to the present invention relates to a base station apparatus of a wireless LAN system that conforms to the IEEE802.11b standard, but since the attention is focused only on receiving apparatus here, the base station apparatus will be called a receiving apparatus, instead. As described above, the receiving apparatus is comprised of RF chips, a processing chip and a baseband chip. The receiving apparatus according to the present embodiments has a plurality of RSSIs outputted respectively from a plurality of RF chips inputted to the processing chip. The processing chip averages the plurality of RSSIs and then generates a new RSSI (hereinafter referred to as a “pseudo RSSI”). The processsing chip further outputs the pseudo RSSI to the baseband chip.

With the plurality of RSSIs as initial values, a plurality of RF chips and a chip perform AGC processing on a plurality of baseband analog signals. With the pseudo RSSI as an initial value, the processing chip and the baseband chip perform AGC processing on a signal which has been synthesized by an adaptive array signal processing.

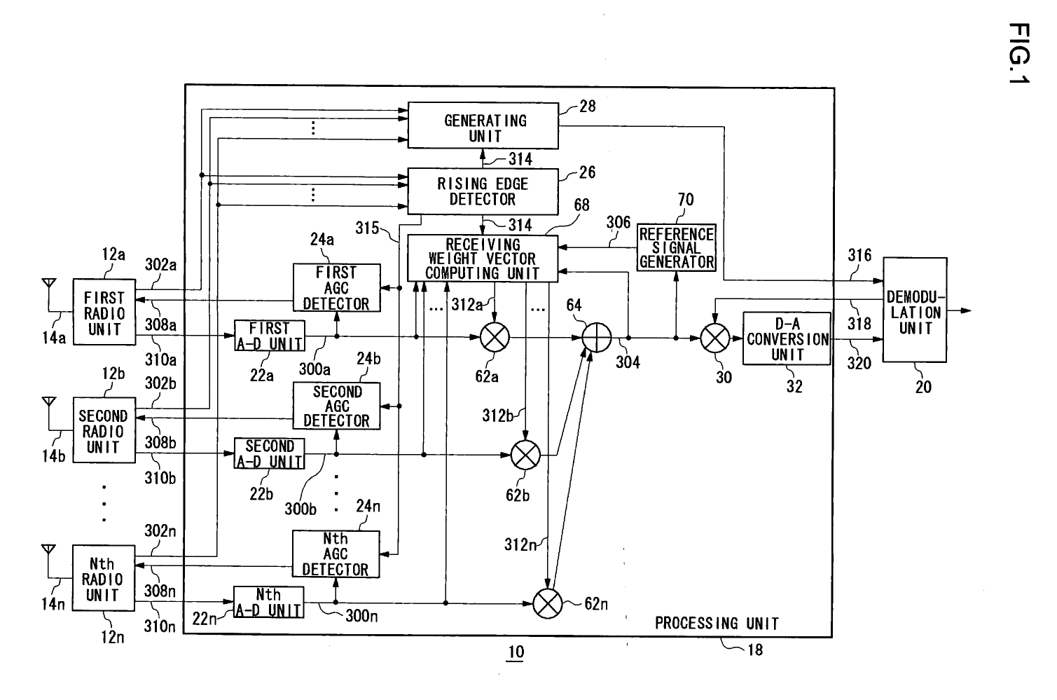

FIG. 1 shows a structure of a receiving apparatus 10 according to the first embodiment of the present invention. The receiving apparatus 10 includes a first antenna 14a, a second antenna 14b, . . . and an Nth antenna 14n, which are generically called antennas 14, a first radio unit 12a, a second radio unit 12b, . . . and an Nth radio unit 12n, which are generically called radio units 12, a processing unit 18 and a demodulation unit 20. The processing unit 18 includes a first A-D unit 22a, a second A-D unit 22b, . . . and an Nth A-D unit 22n, which are generically called A-D units 22, a first AGC detector 24a, a second AGC detector 24b, . . . and an Nth AGC detector 24n, which are generically called AGC detectors 24, a generating unit 28, a rising edge detector 26, a receiving weight vector computing unit 68, a first multiplier 62a, a second multiplier 62b, . . . and an Nth multiplier 62n, which are generically called multipliers 62, an adder 64, a reference signal generator 70, a multiplier 30 and a D-A conversion unit 32.

Furthermore, signals include a first RSSI 302a, a second RSSI 302b, . . . and an Nth RSSI 302n, which are generically called RSSIs 302, a first control signal 308a, a second control signal 308b, . . . and an Nth control signal 308n, which are generically called control signals 308, a first analog received signal 310a, a second analog received signal 310b, . . . and an Nth analog received signal 310n, which are generically called analog received signals 310, a first digital received signal 300a, a second digital received signal 300b, . . . and an Nth digital received signal 300n, which are generically called digital received signals 300, a timing signal 314, a pseudo RSSI 316, a first receiving weight vector signal 312a, a second receiving weight vector signal 312b, . . . and an Nth receiving weight vector signal 312n, which are generically called receiving weight vector signals 312, a reference signal 306, a digital composite signal 304, a control signal 318, an analog composite signal 320 and an initial-value signal 315. It is to be noted here that the above-described plurality of RF chips correspond to the radio units 12, the above-described processing chip corresponds to the processing unit 18, and the above-described baseband chip corresponds to the demodulation unit 20. Thus, if the processing unit 18 is not provided, the radio units 12 may be directly connected to the demodulation unit 20 and a receiving apparatus comprised of such components will be operable. Among these input-output signals, the analog received signals 310 and the analog composite signal 320 in particular correspond analog signals.

The antennas 14 receives RF analog signals. It is assumed herein that the RF analog signals to be received constitute a burst signal and is spectrum-spread. The directivity of the antennas may be arbitrary and the number of antennas is denoted by N.

The radio units 12 performs a frequency conversion from the RF analog signals received by the antennas 14 to baseband analog signals processed by the processing unit 18 and the demodulation unit 20. Then, the baseband analog signals are outputted as the analog received signals 310. The strength of the baseband analog signals is detected and outputted as RSSIs 302. The processing unit 18 performs an AGC on the baseband analog signals, and outputs their control signals to the radio units 12 as the control signals 308. Based on the control signals 308, the radio units 12 performs an gain control on the baseband analog signals at amplifying units 44. The AGC is carried out to make the analog received signals 310 within a predetermined dynamic range at the time of carrying out analog-to-digital conversion at the A-D units 22 described later.

The rising edge detector 26 detects, based on RSSIs 302, the head of a burst signal constituted by the analog received signals. It is assumed herein that the power value of each of a plurality of RSSIs 302 is compared to a threshold value and if a state where at least one of the power values among the plurality of RSSIs 302 is smaller than the threshold value makes a transition to a state where it is larger than the threshold value, the head of a burst signal is detected. Then, the timing signal 314 is outputted at the timing when the head of a burst signal is detected.

The generating unit 28 generates one pseudo RSSI 316 from a plurality of RSSIs 302. In order to reduce the effect of noise components on the pseudo RSSI 316, the pseudo RSSI 316 is outputted at the timing when the timing signal 314 is inputted. Based on the largest RSSI among the plurality of RSSIs 302, the initial-value signal 315 is outputted to the AGC detectors 24.

The A-D units 22 carry out analog-to-digital conversion for the analog received signals 310. The A-D units 22 output the digital received signals 300. The AGC detectors 24 compare the digital received signals 300 with a predetermined amplitude and output the control signals 308 in accordance with a difference therebetween. That is, the AGC detectors 24 generate the control signals so that the amplitudes of the digital received signals 300 get closer to the predetermined amplitude.

The receiving weight vector computing unit 68 computes receiving weight vector signals 312 necessary for weighting digital received signals 300 from the digital received signals 300, the digital composite signal 304 and the reference signal 306, using an LMS (Least Mean Squares) algorithm. The multipliers 62 weight the digital received signals 300 with the receiving weight vector signals 312, and the adder 64 adds up the outputs of the multipliers 62 so as to output a composite signal 304.

During a training period of LMS algorithm, the reference signal generator 70 outputs as a reference signal 306 a training signal stored in advance. After the training period, the composite signal 304 is compared with and determined by a predefined threshold value and then the result of a decision is outputted as a reference signal 306. The decision may not necessarily be a hard decision but it may also be a soft decision.

The multiplier 30 performs an AGC on the digital composite signal 304, and inputs its control signal as a control signal 318. This AGC is performed so that the analog composite signal 320 of an analog signal corresponding to the digital composite signal 304 stays within a predetermined dynamic range. The D-A conversion unit 32 performs an digital-to-analog conversion on signals outputted from the multiplier 30, and outputs the D-A converted signal as the analog composite signal 320.

The demodulation unit 20 performs an analog-to-digital conversion on the analog composite signal 320, performs an de-spread processing on the A-D converted signal and then demodulates it.

In terms of hardware, the above-described structure can be realized by a CPU, a memory and other LSIs of an arbitrary computer. In terms of software, it can be realized by memory-loaded programs which have managing and scheduling functions or the like, but drawn and described herein are function blocks that are realized in cooperation with those. Thus, it is understood by those skilled in the art that these function blocks can be realized in a variety of forms such as by hardware only, software only or the combination thereof.

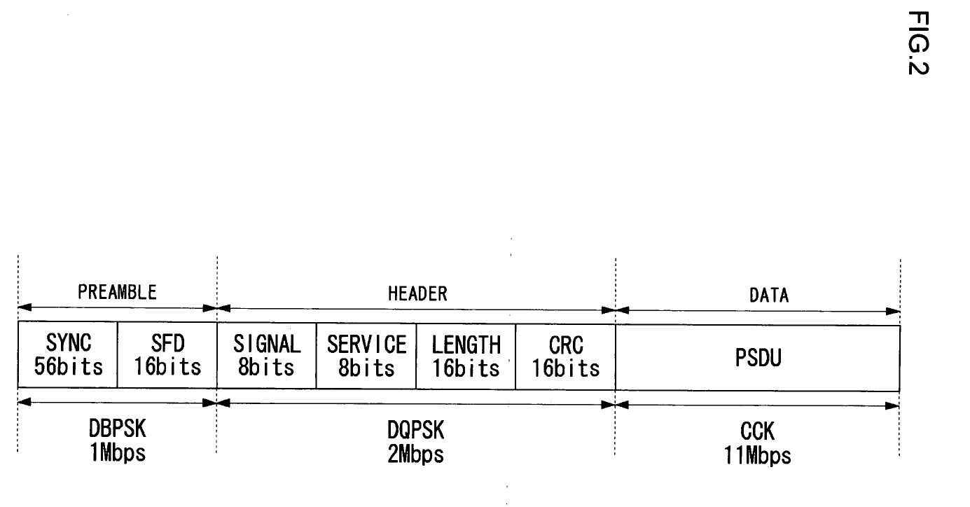

FIG. 2 shows a structure of a burst format according to a first embodiment of the present invention. The one shown in FIG. 2 is a burst format used in the IEEE 802.11b standard. A preamble is placed in the first 144 bits of the burst, and a header is placed in the subsequent 48 bits thereof. The preamble, which is known to a receiving apparatus 10, can also be used as a training signal for LMS algorithm executed in the receiving weight vector computing unit 68 shown in FIG. 1.

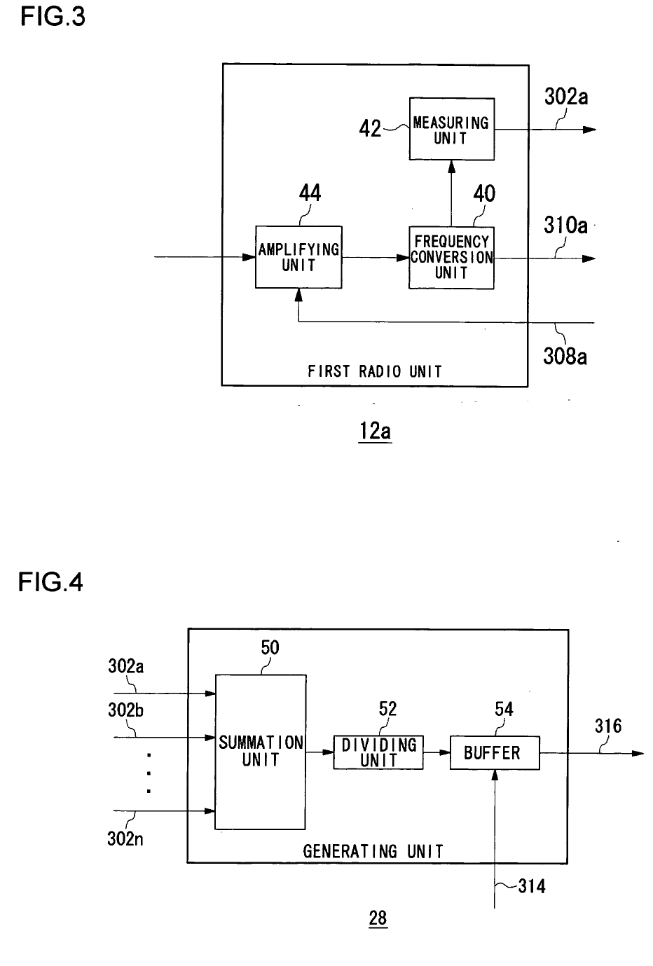

FIG. 3 shows a structure of a first radio unit 12a. The first radio unit 12a includes a frequency conversion unit 40, an amplifying unit 44 and a measuring unit 42.

The frequency conversion unit 40 converts signals to be processed, from radio frequency to baseband frequency, and outputs the thus converted baseband signals as the analog received signals 310. The frequency conversion from radio frequency to baseband frequency may be done indirectly, and may be done by way of one or a plurality of intermediate frequencies, instead. In order to execute these processings the frequency conversion unit 40 includes a frequency oscillator, a mixer, a quadrature detector and so forth.

The amplifying unit 44 amplifies the RF signals based on a gain of the control signal 308 so that the amplitudes of the analog received signals become those within the dynamic range of A-D units 22 shown in FIG. 1.

The measuring unit 42 measures the strength of the baseband signal converted by the frequency conversion unit 40, and outputs the result thereof as RSSIs 302.

FIG. 4 shows a structure of a generating unit 28. The generating unit 28 includes a summation unit 50, a dividing unit 52 and a buffer 54.

The summation unit 50 receives the input of a plurality of RSSIs 302 and computes the summation thereof. The dividing unit 52 divides the summation, computed by the summation unit 50, by N and computes the average value of the plurality of RSSIs 302. The buffer 54 enables the average value, computed by the dividing unit 52, from the timing of a timing signal 314, and makes such adjustment of timing of outputting the average value computed by the dividing unit 52 that the timing is in synchronization with a processing delay caused in a part covering from the multipliers 62 through the D-A conversion.unit 32.

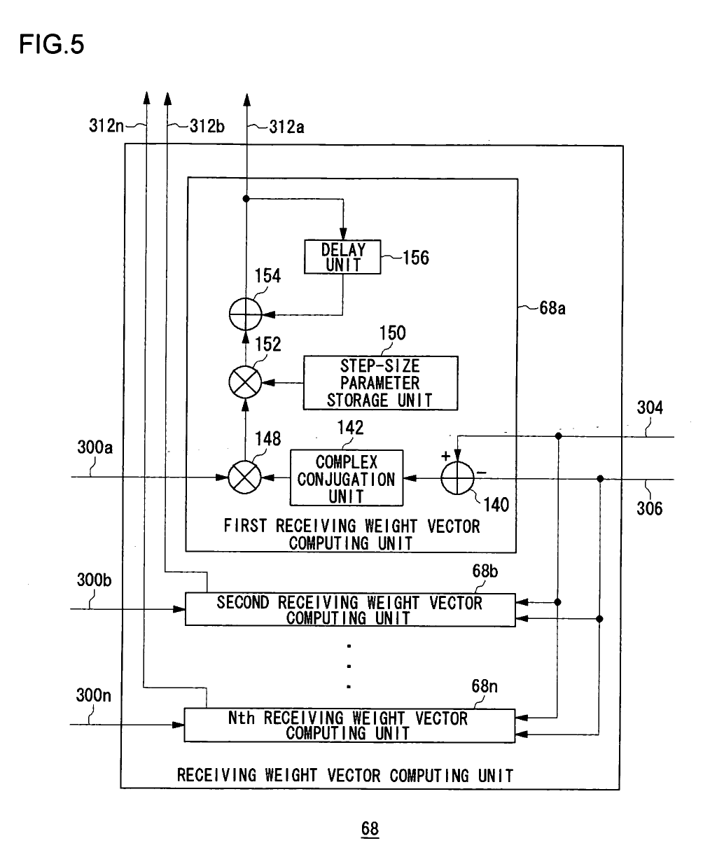

FIG. 5 shows a structure of a receiving weight vector computing unit 68. The receiving weight vector computing unit 68 is a generic term that includes a first receiving weight vector computing unit 68a, a second receiving weight vector computing unit 68b, . . . and an Nth receiving weight vector computing unit 68n. The receiving weight vector computing unit 68 includes an adder 140, a complex conjugation unit 142, a multiplier 148, a step-size parameter storage unit 150, a multiplier 152, an adder 154 and a delay unit 156.

The adder 140 computes a difference between a composite signal 304 and a reference signal for weighting 306 and outputs an error signal, namely, an error vector. This error signal is complex-conjugated by the complex conjugation unit 142.

The multiplier 148 multiplies the complex-conjugated error signal by a first digital received signal 300a so as to output a first multiplication result.

The multiplier 152 multiplies the first multiplication result by a step-size parameter stored in the step-size parameter storage unit 150, and generates a second multiplication result. The second multiplication result is subjected to a feedback by the delay unit 156 and the adder 154 and then added to a new second multiplication result. In this manner, the results of addition updated successively by the LMS-algorithm are respectively outputted as receiving weight vector signals 312.

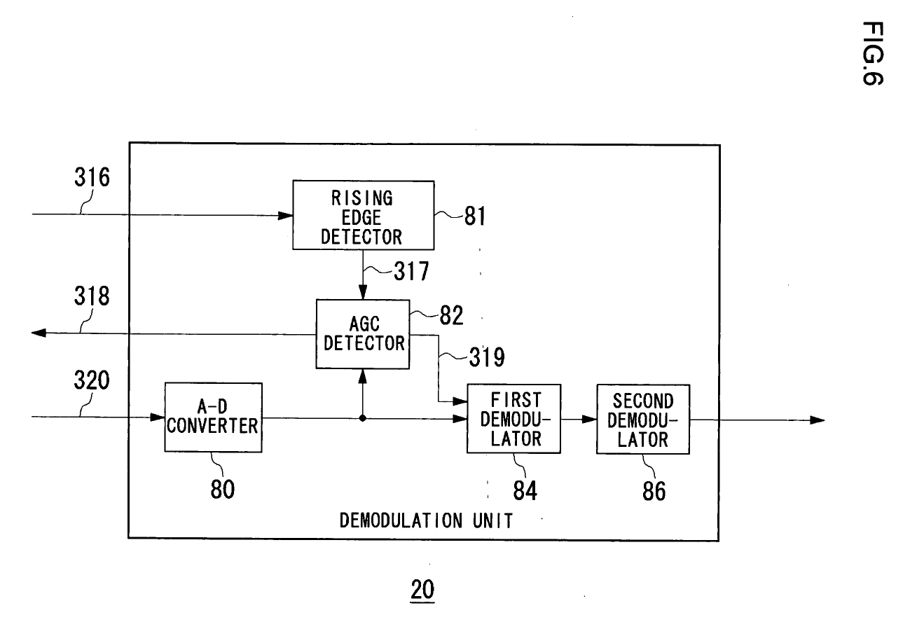

FIG. 6 shows a structure of a demodulation unit 20. The demodulation unit 20 includes an A-D converter 80, a rising edge detector 81, an AGC detector 82, a second demodulator 84 and a first demodulator 86. Signals include a rising-edge detection signal 317 and an AGC-LOCK signal 319.

The A-D converter 80 performs an analog-to-digital conversion on the analog composite signal 320 so as to generate a digital signal. The rising edge detector 81 detects the rising edge of a pseudo RSSI 316, and outputs a rising-edge detection signal 317. Based on this rising-edge detection signal 317, the AGC detector 82 starts an AGC, compares the amplitude of the digital signal converted by the A-D converter 80 with a predetermined amplitude and outputs a control signal 318 for the signal in accordance with the difference therebetween. That is, the control signal of the AGC is generated so that the amplitude of the digital received signal gets closer to the predetermined amplitude. The initial value of the control signal 318 is set based on the pseudo RSSI 316. When the AGC is locked, an AGC-LOCK signal (demodulation start signal) 319 is outputted to the second demodulator 84.

The second demodulator 84 de-spreads the digital signals converted by the A-D converter 80. The first demodulator 86 demodulates the de-spread signals in accordance with a demodulation scheme used in a transmitting apparatus (not shown here) such as BPSK (Binary Phase Shift Keying) and QPSK (Quadrature Phase Shift Keying).

An operation of the receiving apparatus 10 implementing the above structure is as follows. The antennas 14 receive radio frequency signals, respectively, and the radio units 12 frequency-convert the radio frequency signals, then amplify the frequency-converted signals based on the control signals 308 and output the analog received signals 310. The radio units 12 also output RSSIs 302 based on the signals where the RF signals have been frequency-converted. The rising edge detector 26 detects from the RSSIs 302 the head of a burst signal. The generating unit 28 generates a pseudo RSSI 316 from the timing of the head of the burst signal detected by the rising edge detector 26, by averaging a plurality of RSSIs 302. On the other hand, the analog received signals 310 are converted to the digital received signals 300 by the AD units 22, and the AGC detectors 24 generate the control signals 308 based on the digital received signals 300. The receiving weight vector computing unit 68 generates the receiving weight vector signals 312 based on the digital received signals 300. The multipliers 62 multiply the digital received signals 300 by the receiving weight vector signals 312, and the adder 64 sums up the multiplication results so as to output the digital composite signal 304.

At this moment, the reference signal 306, which has been obtained after determining the digital composite signal 304 by the reference signal generator 70, and the digital composite signal 304 are inputted to the receiving weight vector computing unit 68. The multiplier 30 amplifies the digital composite signal 304 based on the control signal 318, and the D-A conversion unit 32 converts the amplified digital composite signal 304 into the analog composite signal 320 so as to be outputted therefrom. The A-D converter 80 converts the analog composite signal 320 into a digital signal, and the AGC detector 82 generates the control signal 318 based on the thus converted digital signal and a predetermined amplitude. At the same time, the thus converted digital signal is de-spread by the second demodulator 84 and then the first demodulator 86 demodulates the de-spread signal.

According to the first embodiment, a processing unit that carries out an adaptive array signal processing averages a plurality of RSSIs and output a pseudo RSSI, and this peudo RSSI is outputted to a demodulation unit. As a result, even if RSSI inputted to the demodulation unit is of a single system, the probability that the signal strength will be a small value can be reduced. Also, the probability that the demodulation unit does not operate normally can be reduced. Furthermore, a processing unit is placed between the radio units and the demodulation unit, and AGC units are provided to operate both between the radio units and the processing unit and between the processing unit and the demodulation unit, respectively. Hence, the digital conversion can be done accurately.

Second embodiment

Similar to the first embodiment, a second embodiment according to the present invention relates also to a receiving apparatus comprised of a plurality of RF chips, a processing chip and a baseband chip. The second embodiment differs from the first embodiment in the method for generating a pseudo RSSI from a plurality of RSSIs. That is, the second embodiment differs from the first embodiment in that the largest RSSI among the plurality of RSSIs is selected and the thus selected RSSI is outputted as a pseudo RSSI. Since the second embodiment concerns a receiving apparatus 10 of the type shown in FIG. 1, the description of the receiving apparatus 10 will be omitted.

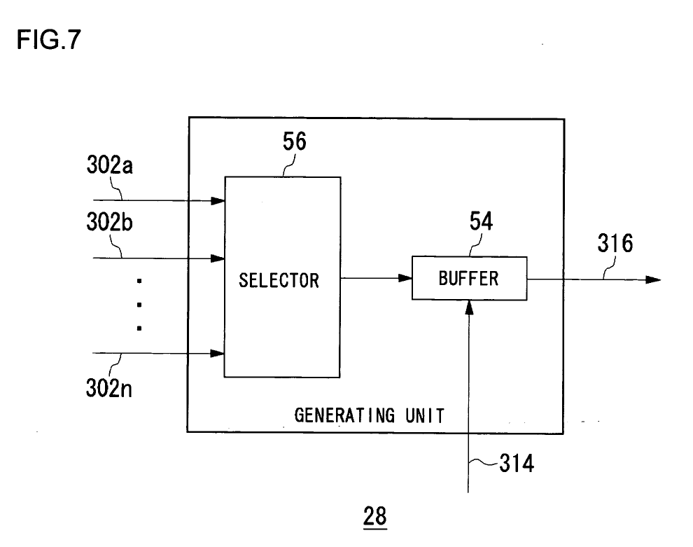

FIG. 7 shows a structure of a generating unit 28 according to the second embodiment. The generating unit 28 includes a generator 28, a selector 56 and a buffer 54.

The selector 56 receives the inputs of a plurality of RSSIs 302, selects from among them one RSSI 302 that corresponds to a signal whose signal strength is maximum, and outputs the thus selected RSSI 302.

According to the second embodiment, the processing unit selects one RSSI, whose signal strength is maximum, from a plurality of RSSIs, generates a pseudo RSSI based on the thus selected RSSI and outputs the pseudo RSSI to the demodulation unit. As a result, even if RSSI inputted to the demodulation unit is of a single system, the probability that the signal strength will be a small value can be reduced. Also, the probability that the demodulation unit does not operate normally can be reduced.

Third embodiment

Similar to the first embodiment, a third embodiment according to the present invention relates also to a receiving apparatus comprised of a plurality of RF chips, a processing chip and a baseband chip. The third embodiment differs from the first embodiment in that not only a plurality of RSSIs are averaged but also the summation is carried out together with carrying out weighting in accordance with the signal strength so as to generate a pseudo RSSI.

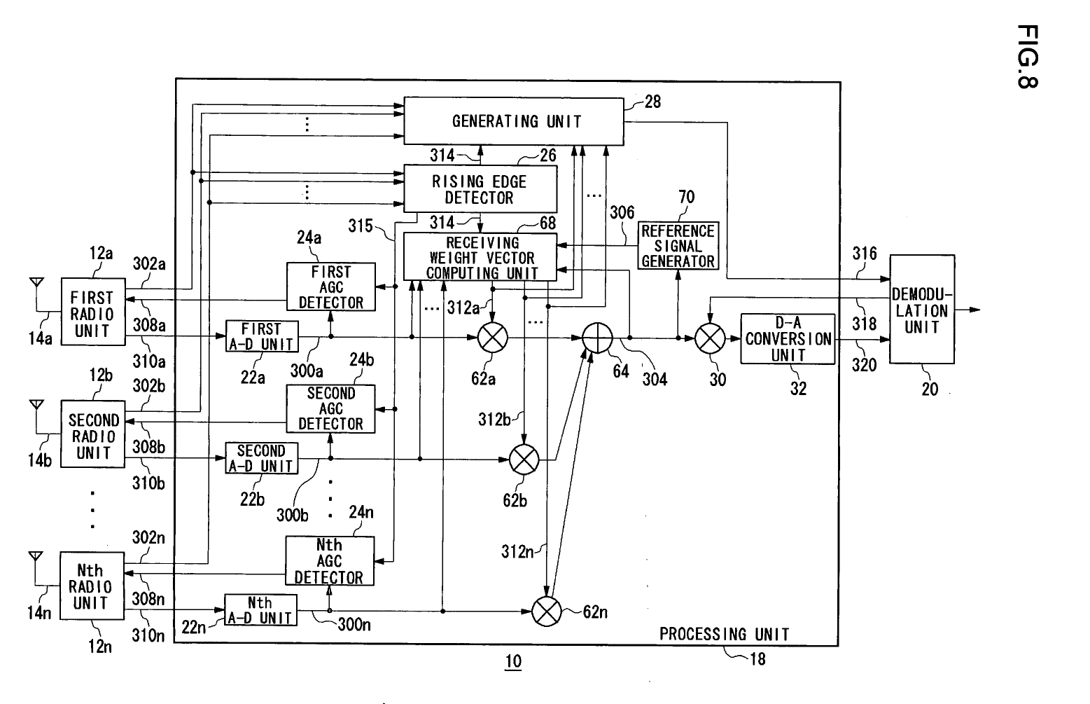

FIG. 8 shows a structure of a receiving apparatus 10 according to the third embodiment. Differing from the receiving apparatus 10 shown in FIG. 1, receiving weight vector signals 312 computed by receiving weight vector computing units 68 are inputted to a generating unit 28. Otherwise, the third embodiment is the same as the receiving apparatus 10 shown in FIG. 1 and the description of such identical structure and components will be omitted.

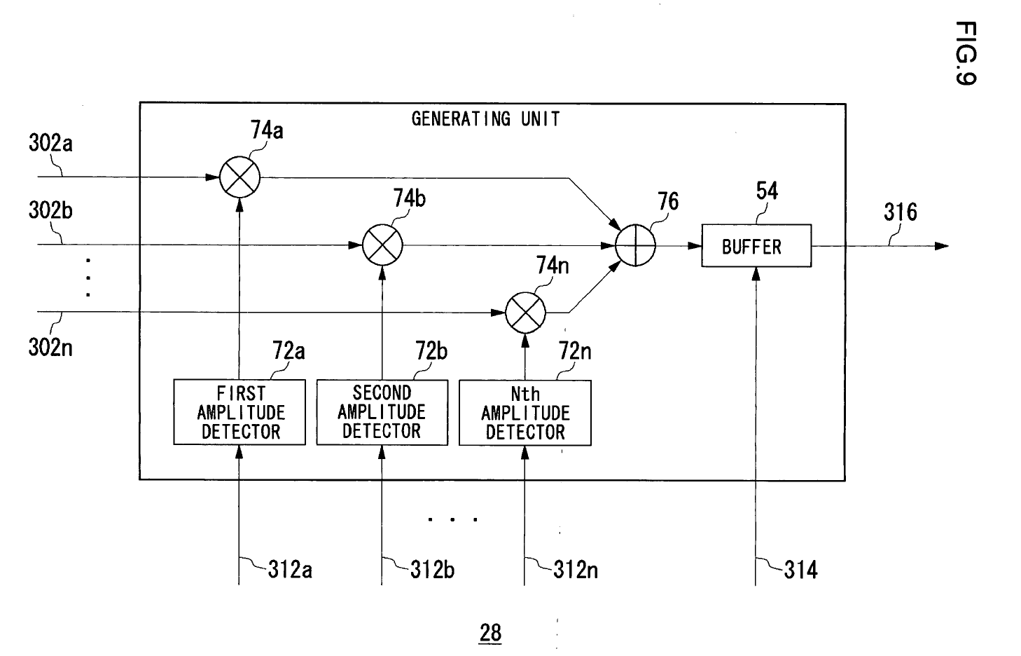

FIG. 9 shows a structure of the generating unit 28. The generating unit 28 includes a first amplitude detector 72a, a second amplitude detector 72b, . . . and an Nth amplitude detector 72n, which are generically called amplitude detectors 72, a first multiplier 74a, a second multiplier 74b, . . . and an Nth multiplier 74n, which are generically called multipliers 74, an adder 76 and a buffer 54.

The multipliers 74 detect respectively the amplitudes of receiving weight vector signals 312 inputted. The amplitude may not be detected in the strict sense, and a power value, instead, may serve the purpose. Also, the amplitude may be represented by an approximate value of amplitude, for example, which is derived by taking the summation of the absolute value of in-phase components of the receiving weight vector signals 312 and the absolute value of quadrature components thereof.

The multipliers 74 multiply RSSIs 302 by the amplitudes detected by the amplitude detectors 72. That is, the RSSIs 302 is weighted with the amplitudes detected by the amplitude detectors 72. The adder 76 adds up signals outputted from the multipliers 74.

According to the third embodiment, the processing unit takes summation while a plurality of RSSIs are being weighted according to the signal strength, so that a pseudo RSSI can be generated in a manner that priority is given to highly reliable RSSIs and then outputted to a demodulation unit. Furthermore, even if RSSI inputted to the demodulation unit is of a single system, the probability that the signal strength will be a small value can be reduced. Also, the probability that the demodulation unit does not operate normally can be reduced.

Fourth embodiment

Similar to the first embodiment, a fourth embodiment according to the present invention relates also to a receiving apparatus comprised of a plurality of RF chips, a processing chip and a baseband chip. The fourth embodiment is characterized in that a plurality of averaged RSSIs in the first embodiment are further added with a waveform stored beforehand in a memory so as to generate a pseudo RSSI.

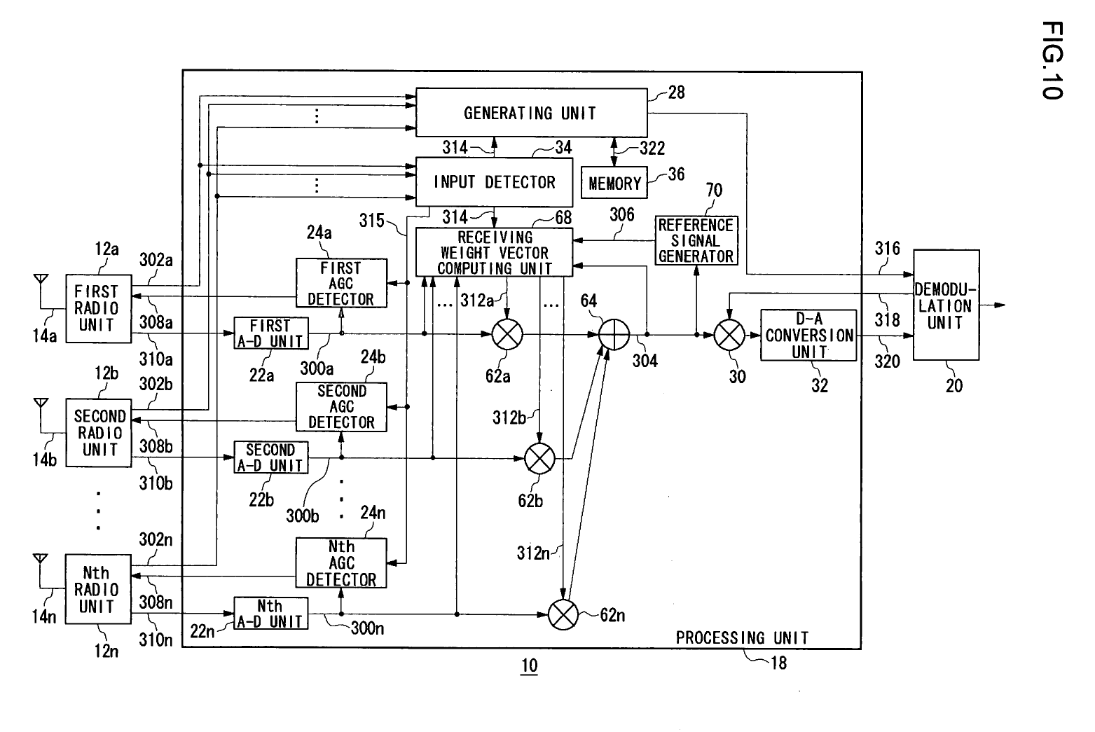

FIG. 10 shows a structure of a receiving apparatus 10 according to the fourth embodiment. Differing from the receiving apparatus 10 shown in FIG. 1, the receiving apparatus 10 according to the fourth embodiment includes an input detector 34 and a memory 36. Signals also include a memory access signal 322. The other components are the same as the receiving apparatus shown in FIG. 1 and the description of such identical structure and components will be omitted.

Similar to the rising edge detector 26 shown in FIG. 1, the input detector 34 detects, based on the RSSIs 302, the head of a burst signal constituted by the analog received signals 310. It is assumed herein that the power value obtained as a result of summing up a plurality of RSSIs 302 is compared to a threshold value and if a state where the power value obtained as a result of summing up the plurality of RSSIs 302 is smaller than the threshold value makes a transition to a state where the power value is larger than the threshold value, the head of a burst signal is detected. Furthermore, for example, the termination of a burst signal whose head has been detected is detected based on the RSSIs 302. As a result, a timing signal 314 is outputted at timings when the head and termination of a burst signal are detected.

The memory 36 stores signals having a predetermined waveform and outputs the stored waveform signals to a generating unit 28 in accordance with an instruction contained in the memory access signal 322. As an example of the stored waveform signals, there is a case where the amplitude increases from the value of zero to a predetermined value at the timing of the head of a burst signal, then the predetermined value is kept intact during the burst signal, and the amplitude decreases from the predetermined value to zero at the timing of the termination of a burst signal. That is, a signal in this case is the one that has the amplitude of a trapezoid-like shape such that the amplitude makes a transition in the shape of a trapezoid if time is set in the horizontal direction and the amplitude in the vertical direction. Here, the timing of the head of a burst signal and the timing of the termination of a burst signal are controlled based on the timing signal 314.

The generating unit 28 generates one pseudo RSSI 316 from waveforms outputted from a plurality of RSSI 302 and a memory 36.

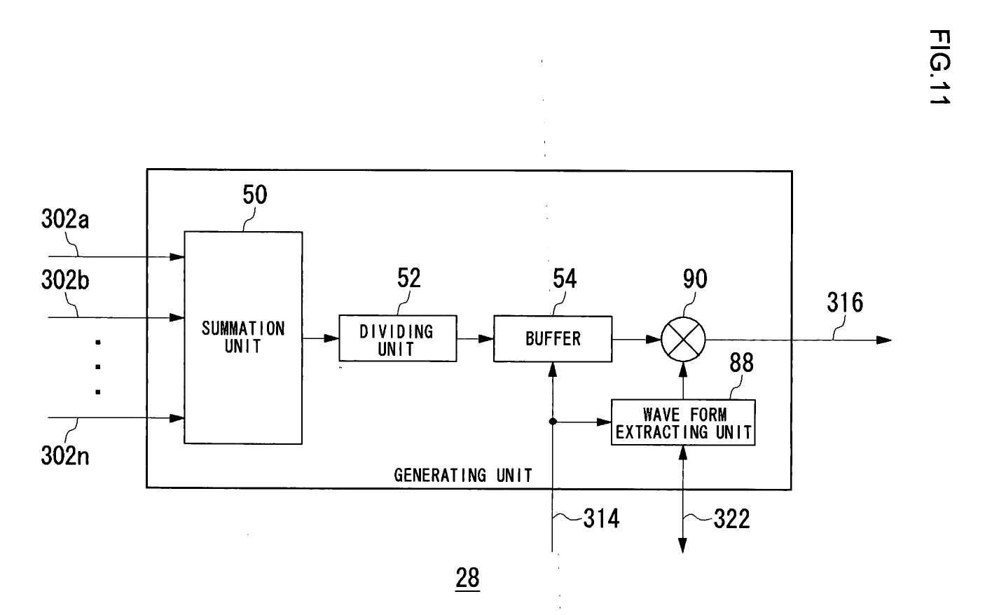

FIG. 11 shows a structure of the generating unit 28. The generating unit 28 includes a summation unit 50, a dividing unit 52, a buffer 54, a waveform extracting unit 88 and a multiplier 90.

Similar to FIG. 4, the summation unit 50 receives the input of a plurality of RSSIs 302 and computes the summation thereof, the dividing unit 52 divides the summation by N, and the buffer 54 enables the result thereof from the timing of a timing signal 314.

The waveform extracting unit 88 reads out, with a memory access signal 322, a predetermined waveform from a memory 36 (not shown in FIG. 11) based on a timing signal 314 over the period from the timing of the head of a burst signal through the timing of the termination thereof. Then the waveform extracting unit 88 outputs the read-out waveform to the multiplier 90. When the timing signal 314 is inputted, the waveform will not be immediately outputted to the multiplier 90 but the waveform will be outputted to the multiplier 90 in synchronization with delay time in the buffer 54. The multiplier 90 multiplies the averaged RSSI outputted from the buffer 54 by the waveform outputted from the waveform extracting unit 88 and outputs a pseudo RSSI 316.

According to the fourth embodiment, the processing unit averages a plurality of RSSIs, furthermore generates a pseudo RSSI by adding a predetermined waveform thereto and outputs the pseudo RSSI. As a result, even if RSSI inputted to the demodulation unit is of a single system, the probability that the signal strength will be a small value is reduced by taking the average and adding a predetermined waveform. Hence, the probability that the demodulation unit does not operate normally is reduced.

Fifth embodiment

Similar to the first embodiment, a fifth embodiment according to the present invention relates also to a receiving apparatus comprised of a plurality of RF chips, a processing chip and a baseband chip. Similar to the fourth embodiment, in this fifth embodiment a waveform is stored beforehand and outputted at a predetermined timing. The fifth embodiment, however, differs from the fourth embodiment in that a plurality of RSSIs are not directly used to generate a pseudo RSSI. In other words, the pseudo RSSI is generated and outputted irrespectively of RSSIs generated based on the received signals.

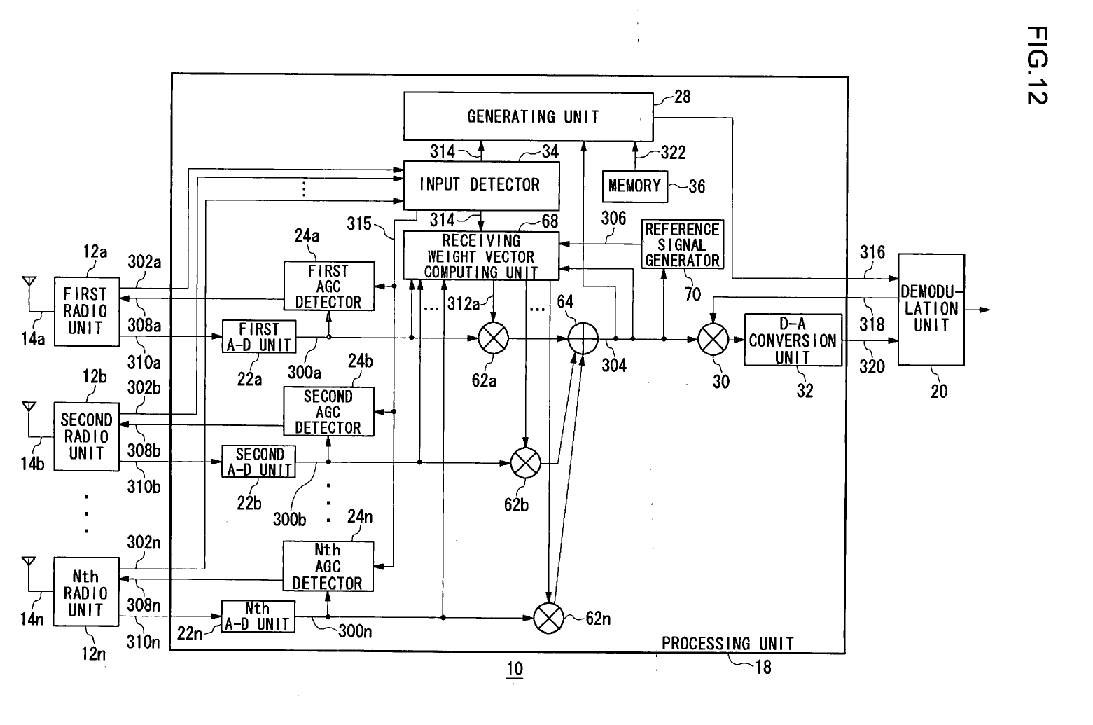

FIG. 12 shows a structure of a receiving apparatus 10 according to the fifth embodiment. Although the receiving apparatus 10 according to this fifth embodiment has a structure similar to that of the receiving apparatus 10 shown in FIG. 10, notice that a plurality of RSSIs are not inputted to a generating unit 28 in FIG. 12. Notice also that a digital composite signal 304 outputted from a multiplier 90 is inputted to the generating unit 28 in FIG. 12.

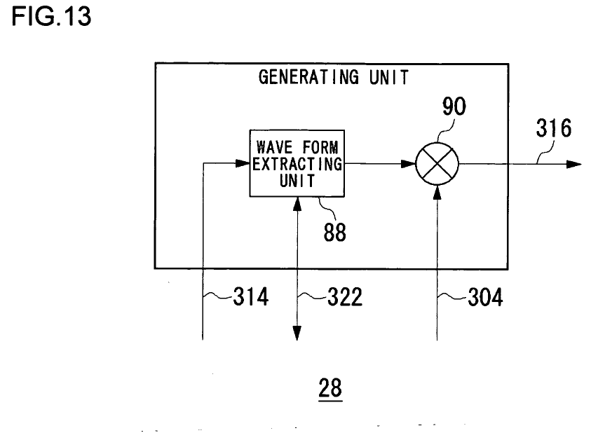

FIG. 13 shows a structure of the generating unit 28. The generating unit 28 includes a waveform extracting unit 88 which corresponds to part of the generating unit 28 shown in FIG. 11 and a multiplier 90.

The waveform extracting unit 88 reads out, with a memory access signal 322, a predetermined waveform from a memory 36 (not shown in FIG. 13) based on a timing signal 314 over the period from the timing of the head of a burst signal through the timing of the termination thereof. Then the waveform extracting unit 88 outputs the read-out waveform to the multiplier 90. Here, the predetermined waveform is one similar to what is shown in the fourth embodiment. When the timing signal 314 is inputted, the waveform will not be instantly outputted to the multiplier 90 but the waveform will be outputted to the multiplier 90 by adjusting the timing so that the timing is in synchronization with a processing delay caused in a part covering from the multipliers 62 through the D-A conversion unit 32 shown in FIG. 12. The multiplier 90 multiplies a digital composite signal 304 by a waveform outputted from the waveform extracting unit 88 and then outputs a pseudo RSSI 316.

According to the fifth embodiment, a processing unit generates a pseudo RSSI at the timing when the head of a burst signal is detected, so that the pseudo RSSI is inputted to the demodulation unit irrespective of the magnitude of the signal strength of the RSSI. Hence, the probability that the signal strength will be a small value becomes lower, and as a result the probability that the demodulation unit does not operate normally is reduced.

The present invention has been described based on the embodiments which are only exemplary. It is understood by those skilled in the art that there exist other various modifications to the combination of each component and process described above and that such modifications are encompassed by the scope of the present invention.

In the above first to fifth embodiments, the description has been given assuming that the receiving apparatus 10 conforms to IEEE 802.11b which is one of the standards for wireless LAN. It is, however, not limited thereto and the receiving apparatus 10 may conform to the wireless LAN standards other than IEEE802.11b, such as IEEE802.11a and IEEE802.11g, and may also be applied to wireless communication systems other than the wireless LAN, for example, a celler system, a personal handyphone system, a third-generation celler system, a fixed wireless communication system and the like. According to this modified example, the present invention may have applicability to various types of wireless systems. That is, it suffices if a receiving apparatus 10 is comprised of at least three chips which are a radio unit 12, a processing unit-18 and a demodulation unit 20.

In the above first to fifth embodiments, the rising edge detector 26 or the input detector 34 compares the power value derived as a result of summing up a plurality of RSSIs 302 with a threshold value. However, the modes of carrying out the present invention are not limited to this, and only one of the plurality of RSSIs may be compared with the threshold value. In other words, for example, among the plurality of RSSIs an RSSI whose signal strength is maximum may be compared to the threshold value, or an RSSI which first becomes larger than the threshold value may be selected. According to this modified example, the addition processing can be skipped. That is, it suffices if the head of a burst signal can be detected.

In the first to fifth embodiments, the AGC processing is carried out in the processing unit 18 and the demodulation unit 20. However it is not limited thereto, and a structure may be such that an amplifying device is provided between the processing unit 18 and the demodulation unit 20 and, hence, the AGC processing is carried out between this amplifying device and the demodulation unit 20. By employing this structure, the power of the processing unit 18 and the multiplier 30 is saved. That is, the receiving apparatus 10 according to this modified example is comprised of a processing unit 18 which synthesizes a plurality of analog received signals, an amplifying device which amplifies the synthesized analog signals and a demodulation unit 20 which demodulates the amplified analog signals, wherein the demodulation unit 20 derives an amplification factor based on the amplified analog signals and the amplifying device amplifies the synthesized analog signals based on the derived amplification factor. According to this modified example, diverse structures are possible. That is, it suffices if the amplitude inputted to the demodulation unit 20 lies within the dynamic range of A-D conversion at the demodulation unit 20.

In the first to fifth embodiments, RSSI signals are produced in the RF chips. However, the present invention is not limited thereto. For example, a structure may be such that the RSSI signals are generated by an external circuit. According to this modified example, various circuit structures are possible.

Although the present invention has been described by way of exemplary embodiments, it should be understood that many changes and substitutions may further be made by those skilled in the art without departing from the scope of the present invention which is defined by the appended claims.

1. A receiving apparatus, comprising:
a frequency conversion unit which frequency-converts a plurality of received analog signals to a plurality of baseband analog signals, respectively;
a synthesis unit which synthesizes the plurality of baseband analog signals that have been frequency-converted by said frequency conversion unit; and
a demodulation unit which converts the synthesized analog signal to a digital signal and then demodulates the digital signal,
wherein said frequency conversion unit derives respectively a plurality of signals indicative of reception strength relative to the plurality of received analog signals,
wherein said synthesis unit processes the plurality of signals indicative of the reception strength and then derives a single signal indicative of the reception strength, and
wherein the synthesized analog signal inputted to said demodulation unit has a band which is approximately equal respectively to bands of the plurality of frequency-converted baseband analog signals outputted from said frequency conversion unit, and said demodulation unit converts the synthesized analog signal to a digital signal and demodulates the digital signal in a manner of reflecting the single signal indicative of the reception strength thereon.

2. A receiving apparatus according to claim 1, wherein said synthesis unit averages the plurality of signals indicative of the reception strength and then derives the single signal indicative of the reception strength.

3. A receiving apparatus according to claim 2, wherein said synthesis unit outputs a signal stored beforehand based on timing at which the plurality of signals indicative of the reception strength were inputted, synthesizes the thus outputted signal with the plurality of averaged signals, and then derives the single signal indicative of the reception strength.

4. A receiving apparatus according to claim 1, wherein said synthesis unit carries out synthesis according to values of reception strength corresponding respectively to the plurality of frequency-converted baseband analog signals while the plurality of signals indicative of the reception strength are being weighted, and then derives the single signal indicative of the reception strength.

5. A receiving apparatus according to claim 1, wherein said synthesis unit selects one signal from the plurality of signals indicative of the reception strength, and then derives the single signal indicative of the reception strength.

6. A receiving apparatus according to claim 1, wherein said synthesis unit outputs the signal stored beforehand as a signal indicative of the reception strength, based on the timing at which the plurality of signals indicative of the reception strength were inputted.

7. A receiving apparatus according to claim 1, wherein said synthesis unit converts respectively the plurality of frequency-converted baseband analog signals into a plurality of digital signals, converts the plurality of digital signals into analog signals after synthesis, and derives respectively amplification factors for the plurality of frequency-converted baseband analog signals to be outputted from said frequency conversion unit, based on the plurality of frequency-converted baseband analog signals, with an initial value as a signal indicative of the reception strength, and
wherein said frequency conversion unit amplifies respectively the plurality of frequency-converted baseband analog signals, based on the thus derived amplification factors, and outputs the amplified signals.

8. A receiving apparatus according to claim 2, wherein said synthesis unit converts respectively the plurality of frequency-converted baseband analog signals into a plurality of digital signals, converts the plurality of digital signals into analog signals after synthesis, and derives respectively amplification factors for the plurality of frequency-converted baseband analog signals to be outputted from said frequency conversion unit, based on the plurality of frequency-converted baseband analog signals, with an initial value as a signal indicative of the reception strength, and
wherein said frequency conversion unit amplifies respectively the plurality of frequency-converted baseband analog signals, based on the thus derived amplification factors, and outputs the amplified signals.

9. A receiving apparatus according to claim 3, wherein said synthesis unit converts respectively the plurality of frequency-converted baseband analog signals into a plurality of digital signals, converts the plurality of digital signals into analog signals after synthesis, and derives respectively amplification factors for the plurality of frequency-converted baseband analog signals to be outputted from said frequency conversion unit, based on the plurality of frequency-converted baseband analog signals, with an initial value as a signal indicative of the reception strength, and
wherein said frequency conversion unit amplifies respectively the plurality of frequency-converted baseband analog signals, based on the thus derived amplification factors, and outputs the amplified signals.

10. A receiving apparatus according to claim 4 wherein said synthesis unit converts respectively the plurality of frequency-converted baseband analog signals into a plurality of digital signals, converts the plurality of digital signals into analog signals after synthesis, and derives respectively amplification factors for the plurality of frequency-converted baseband analog signals to be outputted from said frequency conversion unit, based on the plurality of frequency-converted baseband analog signals, with an initial value as a signal indicative of the reception strength, and
wherein said frequency conversion unit amplifies respectively the plurality of frequency-converted baseband analog signals, based on the thus derived amplification factors, and outputs the amplified signals.

11. A receiving apparatus according to claim 5, wherein said synthesis unit converts respectively the plurality of frequency-converted baseband analog signals into a plurality of digital signals, converts the plurality of digital signals into analog signals after synthesis, and derives respectively amplification factors for the plurality of frequency-converted baseband analog signals to be outputted from said frequency conversion unit, based on the plurality of frequency-converted baseband analog signals, with an initial value as a signal indicative of the reception strength, and
wherein said frequency conversion unit amplifies respectively the plurality of frequency-converted baseband analog signals, based on the thus derived amplification factors, and outputs the amplified signals.

12. A receiving apparatus according to claim 6, wherein said synthesis unit converts respectively the plurality of frequency-converted baseband analog signals into a plurality of digital signals, converts the plurality of digital signals into analog signals after synthesis, and derives respectively amplification factors for the plurality of frequency-converted baseband analog signals to be outputted from said frequency conversion unit, based on the plurality of frequency-converted baseband analog signals, with an initial value as a signal indicative of the reception strength, and
wherein said frequency conversion unit amplifies respectively the plurality of frequency-converted baseband analog signals, based on the thus derived amplification factors, and outputs the amplified signals.

13. A receiving apparatus according to claim 1, wherein, with one signal indicative of the reception strength as an initial value, said demodulation unit derives an amplification factor for the synthesized analog signals to be outputted from said synthesis unit, based on the synthesized analog signals, and
wherein said synthesis unit amplifies the synthesized analog signal, based on the thus derived amplification factor, and outputs the amplified signal.

14. A receiving apparatus according to claim 2, wherein, with one signal indicative of the reception strength as an initial value, said demodulation unit derives an amplification factor for the synthesized analog signals to be outputted from said synthesis unit, based on the synthesized analog signals, and
wherein said synthesis unit amplifies the synthesized analog signal, based on the thus derived amplification factor, and outputs the amplified signal.

15. A receiving apparatus according to claim 3, wherein, with one signal indicative of the reception strength as an initial value, said demodulation unit derives an amplification factor for the synthesized analog signals to be outputted from said synthesis unit, based on the synthesized analog signals, and
wherein said synthesis unit amplifies the synthesized analog signal, based on the thus derived amplification factor, and outputs the amplified signal.

16. A receiving apparatus according to claim 4, wherein, with one signal indicative of the reception strength as an initial value, said demodulation unit derives an amplification factor for the synthesized analog signals to be outputted from said synthesis unit, based on the synthesized analog signals, and
wherein said synthesis unit amplifies the synthesized analog signal, based on the thus derived amplification factor, and outputs the amplified signal.

17. A receiving apparatus according to claim 5, wherein, with one signal indicative of the reception strength as an initial value, said demodulation unit derives an amplification factor for the synthesized analog signals to be outputted from said synthesis unit, based on the synthesized analog signals, and
wherein said synthesis unit amplifies the synthesized analog signal, based on the thus derived amplification factor, and outputs the amplified signal.

18. A receiving apparatus according to claim 6, wherein, with one signal indicative of the reception strength as an initial value, said demodulation unit derives an amplification factor for the synthesized analog signals to be outputted from said synthesis unit, based on the synthesized analog signals, and
wherein said synthesis unit amplifies the synthesized analog signal, based on the thus derived amplification factor, and outputs the amplified signal.

19. A receiving apparatus according to claim 1, wherein, with one signal indicative of the reception strength as an initial value, said demodulation unit derives an amplification factor for the synthesized analog signals, based on the synthesized analog signals,
the apparatus further comprising an amplifying unit which amplifies the synthesized signals based on the amplification factor and outputs the amplified signals to said demodulation unit.

20. A receiving apparatus, comprising:
a synthesis unit which synthesizes a plurality of inputted analog signals; and
a demodulation unit which converts the synthesized analog signals into digital signals and demodulates the digital signals,
wherein said demodulation unit derives an amplification factor for the synthesized analog signals to be outputted form said synthesis unit, based on the synthesized analog signals, and
wherein said synthesis unit amplifies the plurality of synthesized analog signals based on the derived amplification factor and then outputs the amplified signals to said demodulation unit.

21. A receiving apparatus, comprising:
a synthesis unit which synthesizes a plurality of inputted analog signals;
an amplifying unit which amplifies the synthesized signals; and
a demodulation unit which converts the amplified analog signals into digital signals and demodulates the digital signals,
wherein said demodulation unit derives an amplification factor for the amplified analog signals to be outputted form said amplifying unit, based on the amplified analog signals, and
wherein said amplifying unit amplifies the plurality of synthesized analog signals based on the derived amplification factor.

22. A receiving apparatus, comprising:
a first chip which frequency-converts a plurality of received analog signals to a plurality of baseband analog signals, respectively and outputs the plurality of converted baseband analog signals as a plurality of first signals;
a second chip which inputs the plurality of first signals, synthesizes the plurality of frequency-converted baseband analog signals and outputs the synthesized signal as a second signal; and
a third chip which inputs the second signal, converts the synthesized analog signal to a digital signal and then demodulates the digital signal,
wherein said first chip derives respectively a plurality of signals indicative of reception strength relative to the plurality of received analog signals,
wherein said second chip processes the plurality of signals indicative of the reception strength and then derives a single signal indicative of the reception strength, and
wherein the second signal inputted to said third chip has a band which is approximately equal respectively to bands of the plurality of first signals outputted from said first chip, and said third chip converts the synthesized analog signal to a digital signal in a manner of reflecting the single signal indicative of the reception strength.
